(19) United States
(12) Patent Application Publication
(10) Pub. No.: US 2021/0138336 A1
(43) Pub. Date: May 13, 2021

(54) Multi-Durometer Billiard Cue Tip and Cue Stick with Same

(71) Applicant: Michael Joel Sherman, Henderson, NV (US)

(72) Inventor: Michael Joel Sherman, Henderson, NV (US)

(21) Appl. No.: 17/095,656

(22) Filed: Nov. 11, 2020

Related U.S. Application Data
(60) Provisional application No. 62/934,227, filed on Nov. 12, 2019.

(51) Int. Cl. A63D 15/12; B29C 39/12

(52) U.S. Cl. CPC A63D 15/12; B29K 2075/00; B29C 39/123

(57) ABSTRACT

A cue tip for a billiard cue is provided that includes multiple chemically bonded layers formed of a polyurethane material. Each layer is formed of a different polyurethane material with a different hardness than any adjacent layer. The defined layers include at least a proximal layer and a distal layer of polyurethane and at least one intermediary layer. Additional aspects presented include a leather-infused polyurethane layer and a compressed leather layer.

### CROSS-REFERENCE TO RELATED APPLICATIONS

This nonprovisional application claims the benefit of co-pending U.S. Provisional Patent Application Ser. No. 62/934,227, filed on Nov. 12, 2019, which is incorporated herein in its entirety.

### FIELD OF INVENTION

This invention relates generally to a cue tip usable at an end of a billiard cue stick, and, more particularly, to a cue tip formed of multi-durometer polyurethane materials.

### BACKGROUND OF THE INVENTION

Cue sticks are used by players for striking balls during the course of play of billiard table games, such as pool, carom, or snooker. A cue stick has a striking end and a gripping end. A cue stick may be one-piece or multi-piece. Commonly it may be a two-piece cue stick that is separable into two generally equal portions, the shaft and the butt. The shaft extends from the distal striking end, which is fitted with a ferrule carrying a cue tip, to a proximal joint collar. The butt extends from a distal joint pin to the bumper at the proximal end of the cue stick. To join the two portions to create the full-length cue stick, the joint pin and joint collar are engaged.

The distal tip of the cue stick, the cue tip, is used to strike the cue ball. Cue tips typically have the shape of a short cylinder with a flat proximal face for attaching to the ferrule and a convex distal face for impacting the ball. The cue tip typically has a diameter of 13 mm in size, though the size may vary from 8 mm to 14 mm. The energy from the strike is transferred from the cue tip to the cue ball, with the result being the desired accuracy, speed, and spin. Due to the importance of the cue tip in the striking of the cue ball, attention has been focused on the cue tip.

A variety of cue tips are offered to players. Cue tips are available in multiple styles, with a variety of curvatures, and with options in hardness. The hardness of the cue tip may be selected based on the player's style of play and preference and the purpose of the cue. For example, a player may select a different hardness when breaking the pool cue, when spin is desirable, when a hard strike is wanted, etc. Though some very hard pool cue tips, such as breaking cue tips, are formed from phenolic resin, most pool cue tips are made of layers of compressed leather. The level of hardness may be varied by the manufacturer by the amount of compression pressure that was used in compressing the layers of leather with more compression resulting in a harder cue tip.

Softer tips have some advantages. They provide more control and enhance the spin or “English” that can be created when the point of impact is not on the center of the cue ball. These advantages originate because the softer tip absorbs more of the strike impact causing the tip to stay on the cue ball for a slightly longer time.

However, softer tips also have disadvantages. The smooth convex shape of the distal surface will become misshaped or flattened more quickly due to the effect of the repeated ball impact on the softer material. And the softer tip will tend to “mushroom” or bulge out over the top edge of the ferrule. Thus, the tendency toward deformation makes it more difficult to maintain the softer tip than the harder tip.

A harder tip will generally last longer, hold its shape longer, and provide a more efficient hit by providing more speed to the cue ball for a given cue speed. A harder tip produces a more powerful strike, because hard tips do not absorb as much impact and do not stay on the cue ball as long as a softer tip would. Though harder tips play more consistently, last longer and require less maintenance, they create less spin and are more liable to miscue if the cue ball is not struck at the center point.

Currently, the hardness or softness of a cue tip is dependent upon the pressure applied to layers of leather during the manufacturing process, so there is no way to finetune the hardness or softness to meet the needs and preferences of players. Particularly professional players may desire customized cue tips for particular plays.

Accordingly, there is a need for a pool cue tip that can be manufactured to have a precise hardness (including hard, medium hard, medium, medium soft, and soft) characteristic, which allows the pool cue tip to meet the demands of players.

The discussion above is merely provided for general background information and is not intended to be used as an aid in determining the scope of the claimed subject matter.

### BRIEF SUMMARY OF THE INVENTION

The present invention is directed to a billiard cue tip having multiple polyurethane layered regions with adjacent regions having different hardnesses or durometers. The hardness of these regions can be easily varied and finetuned by the manufacturer to meet the preferences of players.

The cue tip includes at least three sections or layers, a proximal layer configured to attach to a ferrule of a cue stick, an intermediary layer, and a distal layer that impacts the cue ball during the strike. The proximal layer is substantially cylindrical with a flat proximal end that is typically adhesively attached to the flat distal surface of the ferrule. The outermost portion of the distal layer has a convex curve. The cue tip may include one or more intermediary layers disposed between the distal layer and the proximal layer.

Adjacent layers have different hardnesses or “durometers”. Commonly, the durometer of polymers and elastomers is measured on scales developed by Albert Ferdinand Shore. These scales are the “Shore durometer A” scale and “Shore durometer D” scale. Higher numbers on the Shore A scale and Shore D scale indicate a harder material that is more resistant to indentation. Lower numbers on the scales indicate a softer material that is less resistant to indentation. The A scale and D scale overlap, as shown in FIG. 14.

In one aspect of the invention, the distal layer of the cue tip is formed of a material having a hardness that is less than the hardness of the proximal cylindrical layer of the cue tip, which forms a softer cue tip.

In another aspect of the invention, the distal layer of the cue tip is formed of a material having a hardness that is greater than the hardness of the proximal cylindrical layer of the cue tip, which forms a harder cue tip.

In further aspect of the invention, the cue tip comprises three layered regions of polyurethane material.

In an additional aspect of the invention, the cue tip comprises more than three layered polyurethane regions.

In a further aspect of the invention, all layered polyurethane regions except the distal region are cylindrical.

In another aspect of the invention, the multiple polyurethane regions comprise at least three layers, the distal layer has a hardness less than the hardness of the proximal layer and less than the hardness of the one or more intermediate layers.

In an additional aspect of the invention, one or more of the intermediary layers comprise polyurethane infused with another substance.

In a further aspect of the invention, one or more of the intermediary layers comprise compressed layers of leather.

In another aspect of the invention, the one or more intermediary layers comprise compressed layers of leather that are adhesively bonded to adjacent layers.

In another aspect of the invention, the distal layer, one or more intermediary layers, and the proximal layer are chemically bonded together.

The object of the invention is to provide a pool cue tip which gives an improved performance over the above described prior art pool cue tips and which allows the manufacturer to finetune the hardness of the cue tip to meet the preferences of players.

These and other objects, features, and advantages of the present invention will become more readily apparent from the attached drawings and from the detailed description of the preferred embodiments which follow.

### BRIEF DESCRIPTION OF THE SEVERAL VIEWS OF THE DRAWINGS

The preferred embodiments of the invention will hereinafter be described in conjunction with the appended drawings, provided to illustrate and not to limit the invention, where like designations denote like elements.

FIG. 1 is a side view of a two-part pool cue with the pool cue tip of the present invention attached at the distal end of the pool cue stick.

FIG. 2A is an exterior side view of an embodiment of a pool cue tip of the present invention.

FIG. 2B is a cut view of the embodiment of FIG. 2A of a pool cue tip of the present invention.

FIG. 3A is an exterior view of an embodiment of a pool cue tip of the present invention.

FIG. 3B is a cut view of the embodiment of FIG. 3A of a pool cue tip of the present invention.

FIG. 4A is an exterior view of an embodiment of a pool cue tip of the present invention.

FIG. 4B is a cut view of the embodiment of FIG. 4B of a pool cue tip of the present invention.

FIG. 5A is an exterior view of an embodiment of a pool cue tip of the present invention.

FIG. 5B is a cut view of the embodiment of FIG. 5A of a pool cue tip of the present invention.

FIG. 6A is an exterior view of an embodiment of a pool cue tip of the present invention.

FIG. 6B is a cut view of the embodiment of FIG. 6A of a pool cue tip of the present invention.

FIG. 7A is an exterior view of an embodiment of a pool cue tip of the present invention.

FIG. 7B is a cut view of the embodiment of FIG. 7A of a pool cue tip of the present invention.

FIG. 8A is an exterior view of an embodiment of a pool cue tip of the present invention.

FIG. 8B is a cut view of the embodiment of FIG. 8B of a pool cue tip of the present invention.

FIG. 9A is an exterior view of an embodiment of a pool cue tip of the present invention.

FIG. 9B is a cut view of the embodiment of FIG. 9A of a pool cue tip of the present invention.

FIG. 10A is an exterior view of an embodiment of a pool cue tip of the present invention.

FIG. 10B is a cut view of the embodiment of FIG. 10A of a pool cue tip of the present invention.

FIG. 11A is an exterior view of an embodiment of a pool cue tip of the present invention.

FIG. 11B is a cut view of the embodiment of FIG. 11B of a pool cue tip of the present invention.

FIG. 12A is an exterior view of an embodiment of a pool cue tip of the present invention.

FIG. 12B is a cut view of the embodiment of FIG. 12A of a pool cue tip of the present invention.

FIG. 13 is an exterior view of an embodiment of a pool cue tip of the present invention before final finishing.

FIG. 14 is a chart of durometer hardness showing the Shore A and Shore D scales.

FIG. 15 is a perspective view of an embodiment of an attachment system of a pool cue tip of the present invention.

FIG. 16 is a perspective view of an embodiment of an attachment system of a pool cue tip of the present invention.

FIG. 17 is a side view of an aspect of a pool cue tip of the present invention.

FIG. 18 is a side view of an aspect of a pool cue tip of the present invention.

FIG. 19 is a side view of an aspect of a pool cue tip of the present invention.

FIG. 20 is a side view of an aspect of a pool cue tip of the present invention.

FIG. 21 is a side view of an aspect of a pool cue tip of the present invention.

Like reference numerals refer to like parts throughout the several views of the drawings.

### DETAILED DESCRIPTION OF THE INVENTION

Shown throughout the figures, the present invention is directed toward a multi-durometer pool cue tip formed of layers, at least some layers of which are formed of polyurethane materials having different hardnesses or durometers than adjacent layers. The polyurethane used has hardness values ranging from 60 Shore A to 80 Shore D. In one aspect, all-polyurethane multi-durometer pool cue tips are disclosed in which all layers are formed of polyurethane materials. In another aspect poly-infused multi-durometer pool cut tips are disclosed in which polyurethane is infused with another substance to form one or more layers. In a further aspect, hybrid multi-durometer pool cue tips are disclosed in which at least one layer is formed of compressed leather and is combined with multiple layers of polyurethane. The pool cue tip of the present invention provides a manufacturer the ability to finetune the design of the layers of materials to fashion a pool cue tip with customized characteristics to meet the needs of players having an array of playing styles and for use in a variety of playing situations.

Referring now to FIG. 1, a multi-durometer polyurethane cue tip, shown generally as reference number 10, is illustrated in accordance with a preferred embodiment of the present invention. The multi-durometer polyurethane cue tip 10 is disposed at the distal end of the pool cue stick 20. The pool cue stick 20 may be formed in a single piece or multiple engageable pieces. For example, the pool cue stick 20 shown in FIG. 1 is a typical two-piece cue stick 20. The proximal piece extends from the proximal bumper 19 to butt cap 18 to butt 17 to forearm 16 to collar 15 to the distal joint pin 14. The distal piece extends from the collar joint 13 to the shaft 12 to the ferrule 11 to the distal pool cue tip 10.

The cue tip 10 comprises multiple sections or layers 40, which include at least a proximal layer 40A (the innermost layer), a distal layer 40N (the outermost layer), and one (penultimate proximal layer 40B) or more intermediary layers that are fixedly joined together during the manufacturing process. The proximal layer 40A is substantially cylindrical with a substantially flat bottom 39 that is configured to be attached to the substantially flat top 49 (FIGS. 15-16) of the ferrule 11. The distal layer 40N is configured with a convex upper surface 30. The cue tip 10 may be wider or narrower, and the convex upper surface 30 may have any of a variety of curvatures, as seen in FIGS. 17-21. The curvature circle of FIG. 17 shows that the convex upper surface 30A has a greater curvature 25A than the curvature 20B of the convex upper surface 30B of FIG. 18, than the curvature 20C of the convex upper surface 30C of FIG. 19, than the curvature 20D of the convex upper surface 30D of FIG. 20, and than the curvature 20E of the convex upper surface 30E of FIG. 21. The curvatures based on a smaller diameter circle, may be termed a “dime” curvature, while a curvature based on a medium diameter circle may define a “nickel” curvature, and a curvature based on a larger diameter circle may define a “quarter” curvature.

By varying the layer materials, the thicknesses of the various layers 40A, 40B, 40C, . . . 40N, the hardnesses of the layers 40A, 40B, 40C, . . . 40N, and the numbers of layers 40A, 40B, 40C, . . . 40N, great flexibility is provided to the manufacturer to produce a pool cue tip 10 with specific, defined qualities. Though both hard and soft cue tips are now available, the inventive cue tip 10 can be produced in a multitude of varieties and is not limited to merely hard and soft variations. For instance, a thin distal surface may be softer to enable the player to create spin, but the layer or layers below the distal surface may be harder to provide stability and reduce maintenance requirements.

An exemplary soft cue tip 10 comprising three layers 40A, 40B, 40N polyurethane, with each layer formed of a polyurethane material having a different durometer, is shown in the exterior view of FIG. 2A and in the cut view of FIG. 2B. In this exemplary soft cue tip 10, the proximal layer 40A is formed of a 95 Shore A polyurethane material, the first (and only) intermediary layer 40B is formed of 80 Shore D polyurethane material, and the distal layer 40N is formed of 60 Shore A polyurethane material. This first exemplary cue tip 10 illustrates that the durometers of all of the layers may be different and that there may be only three layers.

An exemplary medium/soft cue tip 10 comprising four layers 40A, 40B, 40C, 40N of polyurethane is shown in the exterior view of FIG. 3A and in the cut view of FIG. 3B. In this exemplary medium/soft cue tip 10, the proximal layer 40A is formed of 70 Shore A polyurethane material, the first (proximal) intermediary layer 40B is formed of 60 Shore A polyurethane material, the second intermediary layer 40C is formed of 70 Shore A polyurethane material, and the distal layer 40N is formed of 95 Shore A polyurethane material. This medium/soft cue tip 10 of FIGS. 3A, 3B illustrates that some of the durometers of non-adjacent layers may be identical and that there may be a total of only four layers of materials.

An exemplary medium cue tip 10 comprising five layers 40A, 40B, 40C, 40D, 40N of polyurethane is shown in the exterior view of FIG. 4A and in the cut view of FIG. 4B. In this exemplary medium cue tip 10, the proximal layer 40A is formed of 95 Shore A polyurethane material, the first intermediary layer 40B is formed of 60 Shore A polyurethane material, the second intermediary layer 40C is formed of 95 Shore A polyurethane material, the third intermediary layer 40F is formed of 60 Shore D and the distal layer 40N is formed of 100 Shore A polyurethane material. This exemplary cue tip 10 illustrates that the layers need not be of the same thickness; instead the thickness may vary from layer to layer. This exemplary cue tip 10 also demonstrates that there may be a total of five layers of materials.

The exterior view of FIG. 5A and the cut view of 5B show an exemplary medium cue tip 10 comprising six layers 40A, 40B, 40C, 40D, 40E, 40 N of polyurethane. In this exemplary medium cue tip 10, the proximal layer 40A is formed of 95 Shore A polyurethane material, the first intermediary layer 40B is formed of 75 Shore A polyurethane material, the second intermediary layer 40C is formed of 60 Shore D polyurethane material, the third intermediary layer 40D is formed of 70 Shore A polyurethane material, the fourth intermediary layer 40E is formed of 50 Shore D polyurethane material, and the distal layer 40N is formed of 95 Shore A polyurethane material. This exemplary cue tip 10 also demonstrates that there may be a total of six layers of materials.

The exterior view of FIG. 6A and the cut view of FIG. 6B show an exemplary hard cue tip 10 comprising seven layers 40A, 40B, 40C, 40D, 40E, 40F, 40N of polyurethane material. The proximal layer 40A is formed of a polyurethane material having a durometer of 95 Shore A, the first intermediary layer 40B is formed of a polyurethane material having a durometer of 60 Shore A, the second intermediary layer 40C, is formed of a polyurethane material having a durometer of 50 Shore D, the third intermediary layer 40D is formed of a polyurethane material having a durometer of 60 Shore D, the fourth intermediary layer 40E is formed of a polyurethane material having a durometer of 50 Shore D, the fourth intermediary layer 40N is formed of a polyurethane material having a durometer of 95 Shore A, and the distal layer 40N is formed of a polyurethane material having a durometer of 75 Shore A. This exemplary cue tip 10 illustrates that in one aspect of the invention (as also seen in FIGS. 2-5), the distal layer 40N has a thickness great enough to extend below the outer edge of the convex surface 30, so the totality of the convex surface 30 is formed of the polyurethane material of the distal layer 40N. This exemplary cue tip 10 also demonstrates that there may be a total of seven layers of materials.

Another exemplary hard cue tip 10 is shown in the exterior view of FIG. 7A and in the cut view of FIG. 7B. This exemplary hard cue tip 10 comprises eight layers 40A, 40B, 40C, 40D, 40E, 40 40G, 40N. The proximal layer 40A is formed of a polyurethane material having a durometer of 95 Shore A, the first intermediary layer 40B is formed of a polyurethane material having a durometer of 50 Shore D, the second intermediary layer 40C is formed of a polyurethane material having a durometer of 60 Shore D, the third intermediary layer 40D is formed of a polyurethane material having a durometer of 95 Shore A, the fourth intermediary layer 40E is formed of a polyurethane material having a durometer of 60 Shore A, the fifth intermediary layer 40F is formed of a polyurethane material having a durometer of 60 Shore A, the sixth intermediary layer 40G is formed of a polyurethane material having a durometer of 70 Shore A, the seventh intermediary layer 40G is formed of a polyurethane material having a durometer of 80 Shore A, and the distal layer 40N is formed of a polyurethane material having a durometer of 50 Shore D. This exemplary cue tip 10 illustrates that in one aspect of the invention (also seen in FIGS. 8A, 8B), the distal layer 40N does not have a thickness great enough to extend below the edge of the convex surface 30, so the convex surface 30 is formed partially of the material of the sixth intermediary layer 40G and partially of the material of the distal layer 40N. This exemplary cue tip 10 also demonstrates that there may be a total of eight layers of materials.

An exemplary cue tip 10 that may be used for breaking or for jump shots is shown in the exterior view of FIG. 8A and in the cut view of FIG. 8B. This exemplary hard cue tip 10 comprises nine layers 40A, 40B, 40C, 40D, 40E, 40 F, 40G, 40H, 40N. The proximal layer 40A is formed of a polyurethane material having a durometer of 95 Shore A, the first intermediary layer 40B is formed of a polyurethane material having a durometer of 60 Shore D, the second intermediary layer 40C is formed of a polyurethane material having a durometer of 70 Shore A, the third intermediary layer 40D is formed of a polyurethane material having a durometer of 60 Shore A, the fourth intermediary layer 40E is formed of a polyurethane material having a durometer of 50 Shore D, the fifth intermediary layer 40F is formed of a polyurethane material having a durometer of 95 Shore A, the sixth intermediary layer 40G is formed of a polyurethane material having a durometer of 50 Shore D, the seventh intermediary layer 40H is formed of a polyurethane material having a durometer of 60 Shore D, and the distal layer 40N is formed of a polyurethane material having a durometer of 70 Shore A. This exemplary cue tip 10 illustrates that in one aspect of the invention, multiple, non-adjacent layers may have the same hardnesses. This exemplary cue tip 10 also demonstrates that there may be a total of nine layers of materials.

FIGS. 9A and 9B illustrate a first exemplary hybrid cue tip 10. This exemplary hybrid cue tip 10 comprises three layers 40A, 40B, 40N, which include two layers of polyurethane and one layer of polyurethane infused with another substance. The proximal layer 40A and the distal layer 40N are each formed of a polyurethane material. The first intermediary layer 40B, which is disposed between the proximal layer 40A and the distal layer 40N, is formed of a polyurethane material that is infused with leather, cork, or other substance. To create the leather-infused polyurethane, the leather is granulated or fragmentalized. The particulated leather is blended into a mixture of an isocyanate and a polyol that together form a thermosetting mixture, which is an uncured resin. Similarly, the cork-infused polyurethane is formed from particulated cork. This exemplary cue tip 10 illustrates that in one aspect of the invention, infused polyurethane may be used for one of the layers. The infused polyurethane layer may be chemically bonded or adhesively bonded to the adjacent layers.

In FIGS. 2A-9B, the adjacent polyurethane layers are chemically bonded to the adjacent layers by the polymerization and/or crosslinking processes that occur during the curing of the polyurethane of the layers.

FIGS. 10A and 10B illustrate a second type of cue tip which is a hybrid tip formed of polyurethane layers with at least one layer of compressed leather. This exemplary hybrid cue tip 10 comprises three layers 40A, 40B, 40N, which include two layers 40A, 40N of a polyurethane material and one layer 40B of compressed leather, which is disposed between the proximal layer 40A and the distal layer 40N. This exemplary cue tip 10 illustrates that in one aspect of the invention, compressed leather may be used for one or more layers. The top surface of the compressed leather layer is adhesively bonded to the bottom surface of the distal layer 40N. The bottom surface of the compressed leather layer is adhesively bonded to the top surface of proximal layer 40A.

FIGS. 11A and 11B illustrate a third type of cue tip 10, which has at least one layer of infused polyurethane. The illustrated exemplary poly-infused cue tip 10 comprises six layers 40A, 40B, 40C, 40D, 40E, 40N which include four layers 40A, 40B, 40D, 40N of a polyurethane material and two layers 40C, 40E of infused polyurethane. This exemplary hybrid cue tip 10 illustrates that in one aspect of the invention, infused polyurethane may be used for multiple layers with multiple layers of polyurethane material of differing durometers.

FIGS. 12A and 12B illustrate a fourth type of cue tip 10 that is a combination of the hybrid pool tip and the poly-infused pool tip. The exemplary combination cue tip 10 illustrated comprises three layers 40A, 40B, 40N. The proximal layer 40A is formed of infused polyurethane, the intermediary layer 40B is formed of compressed leather, and the distal layer 40N is formed of a polyurethane material. This exemplary combination cue tip 10 illustrates that in one aspect of the invention, one or more layers of infused polyurethane, one or more layers of compressed leather, and one or more layers of polyurethane material are fixedly bonded together to form the cue tip 10.

To form the cue tip, a first thermosetting polyurethane composition (for forming the first layer) is created by mixing an isocyanate compound with a polyol compound and a curing agent. Additives may also be included, such as catalysts, surfactants, accelerators, chain extenders, cross linkers, pigments or dyes, and fillers. Preferably, an open casting method is used, and this first liquid thermosetting polyurethane composition is poured into a mold (which may be a flat open-top tray up to several feet long by several feet wide) to form the first layer (40A or 40N) of the cue tip 10. The particular mixture will remain liquid and mobile for a period (the “filling time” or “pour time”) sufficiently long to transfer the mixture from the mixing reservoir into the bottom of the mold to create the first layer. After being received into the mold, the mixture begins to become creamy and begins to gel.

The mold containing the polyurethane mixture is then heated by being placed in an oven or on a heated table to speed polymerization and crosslinking within the polyurethane. After partially curing the first layer, a second layer is created in the same manner, by mixing and dispensing an isocyanate compound, polyol compound, and a curing agent onto the first layer. In one exemplary method, the second layer is dispensed onto the first layer immediately after the first layer beings to gel. In another exemplary method, the second layer is dispensed onto the first layer after the first layer has been partially cured. In both of these exemplary methods, the first layer is chemically bonded to the second layer through crosslinking and/or polymerization of the polyurethane compositions of adjacent layers.

Typically, a mixing method employing an isocyanate prepolymer may be used, which is known as a prepolymer method or a two-shot method because two separate mixing stages occur. A prepolymer is an intermediate stage product that offers operational convenience. An isocyanate prepolymer is created by pre-reacting an excess of isocyanate monomers with the polyol components. The polyol hydroxyl end groups are reacted with isocyanate groups leaving isocyanate functionality at the termini instead of hydroxyls; the prepolymer contains isocyanate-capped polyurethanes, isocyanate-capped versions of the original polyols, and residual unreacted monomeric isocyanate. The isocyanate-rich oligomer composition is much easier to handle on the factory floor than the original monomers (less prone to crystallization, lower volatility, etc.). Optionally, a phenol-formaldehyde resin formulation, a novola, may be used in the two-shot method in which an excess of phenol is reacted with the isocyanate.

The isocyanate prepolymer forms a first liquid stream and the curing agent along with additives forms a second liquid stream. The two streams are mixed by a mixing head and dispensed by the mixing/dispensing machinery into the mold to form the first layer, which is partially cured. Then, for each subsequent layer, the composition of the first or second streams is changed to achieve the new polyurethane composition of the desired durometer. The desired durometer for each polyurethane layer is achieved by judicious choice of structure and composition of the components (isocyanates, polyols, curing agent, additives) of the polyurethane composition and choice of appropriate reaction conditions. Then the mixing, dispensing, and partial or full curing is repeated until all layers have been mixed and poured into the mold. The layered polyurethane is then cured and demolded.

After curing and demolding of the flat layered sheet of polyurethane, the unrefined cue tips 10A are cut from the layered unit. Therefore, the upper surface 30A is not convex, but it is substantially flat, being formed from the top or bottom of the flat layered sheet of polyurethane. The cut and unrefined cue tip 10A is seen in FIG. 13. The diameter and height of the cylinder may vary based on design preferences for the particular type of cue tip 10 being produced. For example, the height may be from about 2.5 mm to about 12 mm. The width, as seen in FIGS. 17-21, may vary from about 8 mm to 14 mm.

The cut and unrefined cue tip 10A may be sold as is, to be shaped by the end user or the technician that will affix the refined cue tip 10 to the ferrule. Or the unrefined cylinder of FIG. 13 with a substantially flat upper surface 30A may be further processed before retail sale. In that case, the cue tip 10A is then rounded with material removed to create the rounded, convex surface 30 of the striking face. The degree of curvature of the convex surface 30 may be any of a variety of curvatures, as shown in FIGS. 17-21. Commonly, a curvature termed a “nickel” curvature or a “dime” curvature may be preferred.

The bottom surface 39 of the pool cue tip 10 may be slightly roughened for better adherence to the top surface 49 of the ferrule 11, if desired.

FIGS. 15 and 16 illustrate exemplary attachment systems for attaching the cue tip 10 to the top of the ferrule 11. FIG. 15 shows a threaded member 35 that is received by a receiving aperture defined by threaded walls 45. FIG. 16 illustrates a cue tip 10 that is designed to be seated upon the top surface 49 of the ferrule 11 to which it is held in place by a bonding layer of adhesive.

The cue tip 10 of the present invention is easier to maintain and less shaping is required than conventional cue tips. The composition of the layers prevents mushrooming. These advantages reduce the need for replacement of the cue tip, thus providing ecological benefits. Through carefully design and ordering of the layers, the cue tip 10 of the present invention can offer a customized experience with specific characteristics for particular type of shot or to enhance a player's style. Further, the inventive cue tip 10 provides a vegan alternative to the conventional compressed leather cue tips.

The invention illustratively disclosed herein suitably may be practiced in the absence of any element which is not specifically disclosed herein.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A cue tip for attaching to a ferrule, comprising:
a proximal layer comprising a substantially flat proximal-layer bottom surface constructed to be secured to said ferrule and comprising a substantially flat proximal-layer upper surface;
a distal layer comprising a convex outer surface and an inner distal-layer surface; and
one or more intermediary layers disposed between said proximal layer and said distal layer; each of said intermediary layers being fixedly attached between two of said proximal layer, said distal layer, and said intermediary layers.

2. The cue tip for attaching to a ferrule as recited in claim 1, wherein:
said proximal layer comprises a polyurethane having a hardness value ranging from 60 Shore A to 80 Shore D;
said distal layer comprises a polyurethane having a hardness value ranging from 60 Shore A to 80 Shore D;
one of said intermediary layers comprise polyurethane having a hardness value ranging from 60 Shore A to 80 Shore D; and
said proximal layer, said one of said intermediary layers, and said distal layer are chemically bonded.

3. The cue tip for attaching to a ferrule as recited in claim 1, wherein at least one of said intermediary layers is formed of leather-infused polyurethane.

4. The cue tip for attaching to a ferrule as recited in claim 3, wherein said leather-infused polyurethane is formed of a particulated leather blended into a thermosetting mixture of an isocyanate and a polyol.

5. The cue tip for attaching to a ferrule as recited in claim 1, wherein at least one of said intermediary layers is formed of compressed leather.

6. The cue tip for attaching to a ferrule as recited in claim 1, wherein:
said proximal layer comprises a polyurethane having a hardness value ranging from 60 Shore A to 80 Shore D;
said distal layer comprises a polyurethane having a hardness value ranging from 60 Shore A to 80 Shore D; and
at least one of said intermediary layers comprises leather-infused polyurethane.

7. The cue tip for attaching to a ferrule as recited in claim 1, wherein:
said proximal layer comprises a polyurethane having a hardness value ranging from 60 Shore A to 80 Shore D;
said distal layer comprises a polyurethane having a hardness value ranging from 60 Shore A to 80 Shore D; and
at least one of said intermediary layers consists of compressed leather.

8. The cue tip for attaching to a ferrule as recited in claim 1, wherein at least one of said intermediary layers consists of polyurethane having a hardness value ranging from 60 Shore A to 80 Shore D.

9. The cue tip for attaching to a ferrule as recited in claim 1, wherein:
said proximal layer consists of a polyurethane having a hardness value of 95 Shore A;
one of said intermediary layers consists of a polyurethane having a hardness value of 80 Shore D; and
said distal layer consists of a polyurethane having a hardness value of 60 Shore A.

10. A cue tip for attaching to a ferrule, consisting of:
a proximal layer constructed to be secured to said ferrule; said proximal layer formed of polyurethane having a hardness value ranging from 60 Shore A to 80 Shore D;
a distal layer comprising a convex outer surface and an inner distal layer surface; said distal layer having a polyurethane hardness value ranging from 60 Shore A to 80 Shore D; and
one or more intermediary layers disposed between said proximal layer and said distal layer; and each of said intermediary layers being fixedly attached between two of said proximal layer, said distal layer, and said intermediary layers.

11. The cue tip for attaching to a ferrule as recited in claim 10, wherein:
each of said intermediary layers has a polyurethane hardness value ranging from 60 Shore A to 80 Shore D; and
each of said intermediary layers is chemically bonded between two of said proximal layer, said distal layer, and said intermediary layers.

12. The cue tip for attaching to a ferrule as recited in claim 10, wherein one of said intermediary layers is formed of leather-infused polyurethane comprising a particulated leather blended into a thermosetting mixture of an isocyanate and a polyol.

13. The cue tip for attaching to a ferrule as recited in claim 10, wherein:
said proximal layer consists of a polyurethane having a hardness value of 70 Shore A;
a first one of said intermediary layers consists of a polyurethane having a hardness value of 60 Shore A; and
said distal layer consists of a polyurethane having a hardness value of 95 Shore A.

14. The cue tip for attaching to a ferrule as recited in claim 10, wherein a second of said intermediary layers is formed of a polyurethane having a hardness value of 70 Shore A.

15. A method of forming cue tips for attaching to ferrules, comprising:
obtaining an isocyanate;
obtaining a first polyol;
mixing said isocyanate and said first polyol to form a first thermosetting mixture/uncured resin;
pouring said first thermosetting mixture into an open mold;
allowing sufficient time to elapse for said first thermosetting mixture/uncured resin to gel;
obtaining a second polyol;
mixing said isocyanate and said second polyol to form a second thermosetting mixture/uncured resin;
pouring said second thermosetting mixture/uncured resin onto said gelled first thermosetting mixture/uncured resin within said open mold; and
allowing sufficient time to elapse for said second thermosetting mixture/uncured resin to gel; wherein said first thermosetting mixture/uncured resin and said second thermosetting mixture/uncured resin are chemically bound.

16. The method of forming cue tips for attaching to ferrules, as recited in claim 15, further comprising:
obtaining a third polyol;
mixing said isocyanate and said third polyol to form a third thermosetting mixture/uncured resin;
pouring said third thermosetting mixture/uncured resin onto said gelled second thermosetting mixture/uncured resin within said open mold; and
allowing time to elapse to cure said first thermosetting mixture/uncured resin, said second thermosetting mixture/uncured resin, and said third thermosetting mixture/uncured resin to form a layered sheet of polyurethane with chemically bonded layers.

17. The method of forming cue tips for attaching to ferrules, as recited in claim 16, further comprising:
demolding said layered sheet of polyurethane; and
cutting cylindrical shapes from said layered sheet of polyurethane.

18. The method of forming cue tips for attaching to ferrules, as recited in claim 17, further comprising:
shaping said cylindrical shapes so that each has an outer convex distal face.

19. The method of forming cue tips for attaching to ferrules, as recited in claim 15, wherein the gelling of said first thermosetting mixture/uncured resin and said second thermosetting mixture/uncured resin consists of a partial curing.

20. The method of forming cue tips for attaching to ferrules, as recited in claim 15, further comprising:
obtaining a fourth polyol;
mixing said isocyanate and said fourth polyol to form a fourth thermosetting mixture/uncured resin;
mixing particulated leather into said fourth thermosetting mixture/uncured resin; and
pouring said fourth thermosetting mixture/uncured resin onto said gelled second thermosetting mixture/uncured resin within said open mold.
